(19) United States
(12) Patent Application Publication
(10) Pub. No.: US 2024/0371533 A1
(43) Pub. Date: Nov. 7, 2024

(54) CENTRAL COLUMN FOR A TOROIDAL FIELD COIL OF A TOKAMAK PLASMA CHAMBER

(71) Applicant: Tokamak Energy Ltd, Abingdon Oxfordshire (GB)

(72) Inventor: Robert Slade, Abingdon Oxfordshire (GB)

(21) Appl. No.: 18/568,121

(22) PCT Filed: Jun. 30, 2021
(86) PCT No.: PCT/EP21/71497

§ 371 Date: Dec. 7, 2023

(30) Foreign Application Priority Data
Jun. 9, 2021 (GB) 2108265.6

(51) Int. Cl. G21B 1/05; H01F 6/04; H01F 6/06

(52) U.S. Cl. CPC G21B 1/057; H01F 6/04; H01F 6/06

(57) ABSTRACT

A toroidal field coil for a tokamak plasma chamber having a central column. The toroidal field coil comprises first and second high temperature superconductor. HITS, assemblies comprising a respective one or more HITS tapes for conducting electrical current parallel to an axis of the central column. Each of the HITS tapes comprises HITS material having an associated critical current that is dependent on a magnetic field at the HITS tape when the central column is in use. The central column further comprises a cooling mechanism configured to preferentially cool the first HITS assembly relative to the second HTS assembly to reduce or eliminate a difference in the critical current of the or each HITS tape of the first HITS assembly relative to the critical current of the or each HITS tape of the second HITS assembly.

### TECHNICAL FIELD

The present invention relates to a central column for a toroidal field coil of a tokamak plasma chamber, e.g. a tokamak plasma chamber for use in a fusion reactor. In particular, it relates to a central column comprising High Temperature Superconductor (HTS) material.

### BACKGROUND

Superconducting materials are typically divided into “high temperature superconductors” (HTS) and “low temperature superconductors” (LTS). LTS materials, such as Nb and NbTi, are metals or metal alloys whose superconductivity can be described by BCS theory. All low temperature superconductors have a critical temperature (the temperature above which the material cannot be superconducting even in zero magnetic field) below about 30K. The behaviour of HTS material is not described by BCS theory, and such materials may have critical temperatures above about 30 K (though it should be noted that it is the physical differences in superconducting operation and composition, rather than the critical temperature, which define HTS and LTS material). The most commonly used HTS are “cuprate superconductors”—ceramics based on cuprates (compounds containing a copper oxide group), such as BSCCO (Bismuth strontium calcium copper oxide), or REBCO (where Re is a rare earth element, commonly Y or Gd). Other HTS materials include iron pnictides (e.g. FeAs and FeSe) and magnesium diboride (MgB₂).

REBCO is typically manufactured as tapes, with a structure as shown in FIG. 1. Such tape 100 is generally approximately 100 microns thick, and includes a substrate 101 (typically electropolished Hastelloy (TM) approximately 50 microns thick), on which is deposited by IBAD, magnetron sputtering, or another suitable technique a series of buffer layers known as the buffer stack 102, of approximate thickness 0.2 microns. An epitaxial REBCO-HTS layer 103 (deposited by MOCVD or another suitable technique) overlays the buffer stack, and is typically 1 micron thick. A 1-2 micron silver layer 104 is deposited on the HTS layer by sputtering or another suitable technique, and a copper stabilizer layer 105 is deposited on the tape by electroplating or another suitable technique, which often completely encapsulates the tape.

The substrate 101 provides a mechanical backbone that can be fed through the manufacturing line and permit growth of subsequent layers. The buffer stack 102 is required to provide a bi-axially textured crystalline template upon which to grow the HTS layer, and prevents chemical diffusion of elements from the substrate to the HTS which damage its superconducting properties. The silver layer 104 is generally required to provide a low resistance interface from the REBCO to the stabiliser layer, and the stabiliser layer 105 provides an alternative current path in the event that any part of the REBCO ceases superconducting (enters the “normal” state). HTS tapes may be arranged into an HTS cable, which may also be referred to herein as an HTS assembly. An HTS cable, as referred to herein, comprises one or more HTS tapes, which are typically connected along their length via conductive material (normally copper). The HTS tapes may be stacked (i.e. arranged such that the HTS layers are parallel), or they may have some other arrangement of tapes, which may vary along the length of the cable. Notable special cases of HTS cables are single HTS tapes, and HTS pairs. HTS pairs comprise a pair of HTS tapes arranged such that the HTS layers are parallel. Where substrated tape is used, HTS pairs may be type-0 (with the HTS layers facing each other), type-1 (with the HTS layer of one tape facing the substrate of the other), or type-2 (with the substrates facing each other). Cables comprising more than two tapes may arrange some or all of the tapes in HTS pairs. Stacked HTS tapes may comprise various arrangements of HTS pairs, most commonly either a stack of type-1 pairs or a stack of type-0 pairs and (or, equivalently, type-2 pairs).

An important property of HTS tapes (and superconductors in general) is the “critical current” (I_{c}), which is the current at which the HTS would generate sufficient voltage to drive a proportion of the current into the stabilizer layer, at a given temperature and external magnetic field. The characteristic point of the superconducting transition at which the superconductor is considered to have “become normal” is to some extent arbitrary, but it is usually taken to be when the tape generates E₀=10 or 100 microvolts per metre. The critical current may depend on a number of factors, including the temperature of the superconductor and the magnetic field at the superconductor. In the latter case, both the field magnitude and the orientation of the superconductor crystal axes in the field are important.

FIG. 2 shows a cross section of an exemplary REBCO tape 200 in the xz plane. The REBCO layer itself is crystalline, and the principal axes of the REBCO crystal are shown for one point in the tape. The REBCO tape is shown in simplified form with an HTS layer 201, a copper cladding 202, and a substrate 203. The crystal structure of REBCO has three principal axes which are mutually perpendicular, referred to in the art as a, b, and c. For the purposes of this disclosure, any dependence of the critical current on the orientation of the magnetic field component in the ab plane is ignored, so that the a and b axes can be considered interchangeable, such that they will be considered only as the “ab plane” (i.e. the plane defined by the a and b axes). In FIG. 2, the ab plane of the REBCO layer 201 is shown as a single line 210, perpendicular to the c-axis 220. In many tapes the ab plane 210 is aligned closely with the plane of the HTS layer 201, but this is not a general condition.

The critical current of the tape depends on the REBCO crystal thickness and quality. It also has an approximately inverse dependence on the ambient temperature and also the magnitude of the applied magnetic field. Finally, it also depends on the orientation of the applied magnetic field with respect to the c-axis. When the applied magnetic field vector lies in the ab plane 210, the critical current is considerably higher than when the applied magnetic field vector is aligned along the c-axis 220. The critical current varies smoothly between these two extremes in “out of ab plane” field orientation. (In practice, there may be more than one angle at which critical current shows a peak. Furthermore, the amplitude and width of the peaks vary with both applied field and temperature, but for the purposes of this explanation we can consider a tape with a single dominant peak that defines the optimum orientation of applied B field that gives maximum critical current).

REBCO tapes are normally manufactured so that the c-axis is as close to perpendicular to the plane of the tape as possible. However, some commercially available tapes have a c-axis at an angle of up to 35 degrees from the perpendicular in the x/y plane.

For an HTS cable, assuming the cable is at a uniform temperature and in a uniform magnetic field along its entire length, the critical current of all the tapes in the stack will be relatively uniform. In this case, when the cable is attached to a power supply, current will distribute between the tapes in the ratio of the termination resistances at the ends of the cable according to Ohm's law. However, in many circumstances, the current distribution can be affected by a number of factors, such as, variations in the magnitude of the local magnetic field, or variations in the field angle relative to the c-axis of the REBCO layer, either along the length or across the width of the tapes within the cable.

Magnets comprising high temperature superconductors may be used within fusion reactors, such as Spherical Tokamaks (STs), to confine plasmas at very high temperatures. Spherical tokamaks offer significant advantages for commercial fusion power plants, including higher thermal power per unit plasma volume, and significant bootstrap current. These benefits enable smaller, more efficient machines to be developed, accelerating development timescales and reducing recycled power. Progress in understanding the physics of STs is continuing around the world on experimental devices such as MAST, NSTX, and ST40, which all use pulsed resistive magnets.

A commercial power plant requires superconducting magnets for either long pulse or continuous operation and to maximize net electrical power generation. This previously represented a roadblock for STs because the slim central column of the toroidal field (TF) magnet results in magnetic fields on the superconductor beyond the capability of conventional low temperature superconductors (LTS). The recent commercial availability of high-performance REBCO coated conductors (“tapes”) from multiple suppliers makes a high field ST, with a mission to demonstrate net power gain (Q>1) using D-T fuel, feasible at smaller scale than a conventional aspect ratio tokamak using LTS. A 1.4 m major radius HTS ST with 4 T field on axis can achieve this mission if an adequately thick neutron shield (>25 cm) can be implemented.

FIG. 3A shows a vertical cross section through a spherical tokamak 300 comprising toroidal field coils 301, poloidal field coils 303 and a toroidal plasma chamber 305 located within the toroidal field coils 301. The tokamak 300 also comprises a central column 307, which extends through the centres of the plasma chamber 305 and the toroidal 301 and poloidal 303 field coils. Each of the D-shaped toroidal field coils 301 comprises an approximately straight section 309 (the “inboard limb” of the TF coil 301) that extends along the axis A-A′ of the central column 307 and a curved section 311 (the “outboard limb” of the TF coil 301) that is electrically connected to either end of the straight section 309 to form the D-shape. In this example, the spherical tokamak 300 has a major radius of 1.4 m and the central column 307 has a radius of around 0.6 m.

FIG. 3B shows an axial cross section of the central column 307 viewed looking along the axis A-A′. The tokamak 300 comprises 12 toroidal field coils 301 and the respective straight portions 309 of each of the toroidal field coils 301 are angularly spaced about the axis A-A′ of the central column 307 in an equiangular arrangement. The central column comprises a support member 313 that extends along the axis A-A′ and which has a plurality of channels 315 in which the straight sections 309 of the toroidal field coils 311 are housed. The support member 313 may be formed form a plurality of angular segments that fit together like the segments of an orange, with each segment housing an inboard limb 309 of one of the TF coils 301.

FIG. 4 is an axial cross section of an angular segment 400 of the central column 307, comprising one half of a segment of the support member 313, which houses the inboard limb 401 of one of the toroidal field coils 301. Only an “upper” half of the angular segment is shown in FIG. 4, with the omitted “lower” half being a mirror image of the upper half. A plurality of the angular segments 400 can be assembled to form a substantially cylindrical central column 307. The inboard limb 401 of the toroidal field coil 301 is formed by winding multiple turns of HTS cable 402 (the turns (“windings”) may be referred to collectively as a “winding” or “coil” pack), each turn containing HTS tapes extending parallel to the axis of the central column 307 (i.e. into the page with respect to FIG. 4). A portion of the winding pack 401 showing four individual turns of the HTS cables 402 making up the winding pack is shown in more detail in FIG. 5.

In general, existing designs of HTS assemblies (cables) 402 follow those used for low temperature superconductors. These designs assume “cable-in-conduit conductor” (CICC) construction in which the HTS cable 402 comprises stacks of HTS tape 501 surrounded by stabilizer material 502 (such as copper or aluminium) that is provided with a cooling channel 505. The stabiliser 502 and cooling channel 505 are weak so a 35 high strength “jacket” comprising a structural support 503 made of high strength material, such as Inconel, is used to prevent mechanical deformation of the HTS assembly 402 under the electromagnet pressure created when the coil is energized. Insulation 504 is provided between the HTS cables 402 to electrically isolate the HTS cables 402 from one another. The stacks of HTS tape 501 are cooled by flowing a cryogen through a central cooling channel 505 that passes though of the stabilizer material 502. The introduction of the cooling channel 505 and large quantity of soft high conductivity stabilizer 502 into the HTS assembly 402 weakens it such that a relatively strong (i.e. thick) structural support 503 is required. The stacks of HTS tape 501 are evenly spaced around the central cooling channel 505 to ensure that there is uniform cooling of the stacks of the HTS tapes 501. Conventionally, the HTS tapes are provided in a “twisted” or “transposed” arrangement in which the orientation of the HTS tapes varies along the axis of the central column.

Referring again to FIG. 4, the angular segment 400 of the central column 307 has a vacuum gap 403 that separates the cryogenic components (the HTS cables 402 and the support member 313) from neutron shielding 404, the neutron shielding being provided further from the axis of the central column 307 than the winding pack 401 and support member 313.

The use of cable-in-conduit conductors for the HTS assemblies 402 typically results in winding pack current densities (J_{wp}) of much less than 100 A/mm², which means that for a given central column 307 diameter, the area of the central column 307 available for neutron shielding 404 is limited, particularly in smaller tokamaks. Consequently, CICC construction may lead to the HTS coil pack 401 being be subjected to higher nuclear heating than is desirable when the tokamak is operated.

### SUMMARY

According to a first aspect of the present invention there is provided a central column for toroidal field coil of a tokamak plasma chamber, The central column comprises first and second high temperature superconductor, HTS, assemblies comprising a respective one or more HTS tapes for conducting electrical current parallel to an axis of the central column. Each of the HTS tapes comprises HTS material having an associated critical current that is dependent on a magnetic field at the HTS tape when the central column is in use. The central column further comprises a cooling mechanism configured to preferentially cool the first HTS assembly relative to the second HTS assembly to reduce or eliminate a difference in the critical current of the or each HTS tape of the first HTS assembly relative to the critical current of the or each HTS tape of the second HTS assembly.

For example, the magnetic field generated during operation of the toroidal field coil may cause the critical current of the or each HTS tape of the second HTS assembly to be greater than the critical current of the or each HTS tape of the first HTS assembly. As described below, the critical current may depend the strength of the magnetic field and/or a field angle of the magnetic field at the HTS tape. In particular, a magnetic field strength and/or a magnetic field angle at the or each HTS tape of the first HTS assembly may be greater than a magnetic field strength and/or a magnetic field angle at the or each HTS tape of the second HTS assembly. As a result, the critical current of the or each HTS tape of the first HTS assembly may be less than the critical current of the or each HTS tape of the second HTS assembly. The cooling mechanism may then be configured to cool the first HTS assembly to a lower temperature than the second HTS assembly to compensate for the difference in critical currents.

Reducing, or preferably eliminating, the difference in critical current between the first and second HTS assemblies may cause the transport electrical current to be distributed more evenly between them. For example, the cooling mechanism may be configured to ensure that the critical current of the HTS tapes of the first HTS assembly is within 20% of the critical current of the HTS tapes of the second HTS assembly, preferably within 10%, or more preferably within 5%, or even 1%.

The HTS material may be REBCO, for example.

The critical current of each HTS tape may be inversely dependent on the strength of the magnetic field at the HTS tape. The strength of the magnetic field at the first HTS assembly may be greater than the strength of the magnetic field at the second assembly. Generally, the critical current decreases with increasing magnetic field strength (i.e. the critical current is inversely dependent on the strength of the magnetic field) and increasing temperature (i.e. the critical current is inversely dependent on the temperature), e.g. the critical current may be inversely proportional to the strength of the magnetic field (B) and to the temperature (T), and the cooling mechanism is configured to produce a temperature distribution over the first and second HTS assemblies that compensates for the difference of magnetic field strength at the first and second HTS assemblies. For example, when the strength of the magnetic field at the first HTS assembly is greater than the strength of the magnetic field at the second assembly, the cooling mechanism may be configured to cool the first assembly to a lower temperature than the second assembly.

For example, the cooling mechanism may be configured to compensate for a positive radial gradient of the magnetic field (dB/dr, where r is a radial distance from the axis of the central column) by generating a negative radial temperature gradient (dT/dr) between the first and second HTS assemblies. The temperature gradient may be chosen so that the variation in critical current I_{c}(B,T) produced by the gradient of the magnetic field is approximately cancelled.

Each of the HTS tapes may have an associated plane defined with respect to a crystal structure of the HTS material of the HTS tape. The planes may, for example, be ab-planes as mentioned above in connection with the REBCO tape 200 of FIG. 2. The critical current of each HTS tape may depend on a field angle between the magnetic field at the HTS tape and the plane of the HTS tape, the critical current decreasing as the angle increases. The HTS assemblies may be arranged such that the field angle between the magnetic field and the plane of the or each HTS tape of the first assembly is greater than the field angle between the magnetic field and the ab-plane of the or each HTS tape of the second assembly. For each of the HTS assemblies, the respective planes of the HTS tapes of the HTS assembly may be parallel to one another. Optionally, the planes of the HTS tapes in the first HTS assembly may be parallel to the planes of the HTS tapes in the second HTS assembly. For example, the first and second HTS assemblies may each be part of a respective planar pancake coil comprising nested windings of HTS tapes about an axis, the pancake coils being stacked adjacent one another in a face-to-face arrangement. In one example, a maximum critical current of each HTS tape may occur when the magnetic field (B) is parallel to the ab plane of the HTS tape. For example, the cooling mechanism may be configured to cool the first HTS assembly to a lower temperature than the second HTS assembly when the field angle between the magnetic field and the ab-plane of the or each HTS tape of the first assembly is greater than the field angle between the magnetic field and the ab-plane of the or each HTS tape of the second assembly.

A distance between the first HTS assembly and the axis of the central column may be greater than a distance between the second HTS assembly and the axis of the central column, each of the distances being measured in a plane perpendicular to the axis.

The cooling mechanism may comprise one or more channels through which to flow a cryogenic fluid, preferably helium and more preferably supercritical helium.

The or each cooling channel may be (or include a portion which is) substantially straight (i.e. a centre line of the channel is a straight line) and may extend in a direction having a component parallel to the axis of the central column. For example, the or each cooling channel and the HTS tapes may all be (substantially) parallel to the axis of the central column.

A thermal impedance between the or each cooling channel and the first HTS assembly may be less than a thermal impedance between the or each cooling channel and the second HTS assembly.

A shortest distance between the or each cooling channel and the first HTS assembly may be less than a shortest distance between the or each cooling channel and the second HTS assembly, each of the distances being measured in a plane perpendicular to the axis. Such a configuration allows the or each cooling channel to preferentially cool the first HTS assembly relative to the second HTS assembly (at least in the plane in which the distances are measured). In some examples, the or each cooling channel may be closer to the first HTS assembly than to the second HTS assembly along the entirety of the central column.

In some implementations, the or each cooling channel may be located further from the axis of the central column than both the first HTS assembly and the second HTS assembly. Preferably, the or each cooling channel is located further from the second HTS assembly than from the first HTS assembly in order to provide preferential cooling to the first HTS assembly compared to the second HTS assembly.

A density of the cooling channels adjacent the first HTS assembly may be greater than a density of the cooling channels adjacent the second HTS assembly. Alternatively, or additionally, respective cross sectional areas of the cooling channels adjacent the first HTS assembly may be greater than respective cross sectional areas of the cooling channels adjacent the second HTS assembly. These configurations may allow the cooling channels to provide greater cooling power to the first HTS assembly relative to the second HTS assembly.

The first and second HTS assemblies may each comprise a plurality of HTS tapes, each having an associated ab-plane defined with respect to a crystal structure of the HTS material of the HTS tape, respective ab-planes of the HTS tapes being parallel to one another within each of the HTS assemblies.

The HTS magnet may further comprise a support member having one or more channels, the or each channel preferably extending in a direction parallel to the axis of the central column. The first and second HTS assemblies may be provided in the one or more channels of the support member.

At least a part of the central column may be made of a thermally conductive material, such as copper, preferably hard copper, i.e. a material that has a high thermal conductivity at temperatures below the critical temperature of the HTS material in the HTS tapes. In some examples, the material may have a thermal conductivity greater than 100 W/mK, greater than 300 W/mK or even greater than 7000 W/mK for temperatures in a range from 20 K to 40 K. The cooling mechanism may be configured to cool the part of the support member through a face of the support member that is contiguous with a body portion of the part of the support member (i.e. with no interfaces between the body portion and the face). The body portion is in contact with the first HTS assembly and/or the second HTS assembly through one or more walls of the or each channel of the support member in which the first and second HTS assemblies are provided, whereby the first HTS assembly and/or the second HTS assembly is or are cooled by the part of the support member.

At least a portion of the second HTS assembly may be located radially inwards of the first HTS assembly, i.e. extends closer to the axis of the central column than the first HTS assembly. The portion may be in thermal contact with the body portion of the part of the support member cooled by the cooling mechanism, whereby heat is transferred from the portion of the second HTS assembly to the cooling mechanism via the part of the support member cooled by the cooling mechanism. The cooling mechanism may be configured to cool the part of the support member cooled by the cooling mechanism to a temperature that is less than a temperature of each of the HTS assemblies when the central column is in use. For example, the first and second HTS assemblies may be cooled to a temperature from 25 K to 35 K, while the part of the support member may be cooled by the cooling mechanism may be cooled to a temperature from 20 K to 25 K.

The support member may comprise another part located radially inwards of the part cooled by the cooling mechanism and having a higher mechanical strength than the part cooled by the cooling mechanism. The other part may be made from Iconel (TM), for example. The increased mechanical strength resists compression of the central column by the HTS assemblies as a result of the Lorentz forces generated when the central column is in use.

The cooling mechanism may be configured to cool each of the HTS tapes to below a critical temperature of the HTS material in the HTS tape, and preferably to a temperature of less than 30 K, more preferably less than 25 K, e.g. to around 20 K.

According to a second aspect of the present invention there is provided a tokamak plasma chamber comprising a central column according to the first aspect above and a toroidal field coil comprising a plurality of windings of HTS tape, each winding comprising a respective one of the HTS tapes. The tokamak plasma chamber may further comprise a plurality of toroidal field coils configured to provide a toroidal magnetic field inside the plasma chamber when electrical current is passed around windings of the toroidal field coils, the central column comprising a respective first and second HTS assembly for each of the toroidal field coils (i.e. each winding of the toroidal field coil comprising a respective one of the HTS tapes of the first and second HTS assemblies).

The toroidal field coils may, for example, be D-shaped coils in which the windings are arranged to form an inboard limb (corresponding to the straight portion of the D-shape) formed by the HTS tapes of the central column and an outboard limb (corresponding to the curved portion of the D-shape) formed by the other HTS tapes making up each of the windings. Electrical current supplied to a first of the windings of the toroidal field coil circulates around each of the other windings of the coil in turn (as in a solenoid), the electrical current passing along the inboard limb, around the outboard limb and back into the inboard limb for each of the windings.

According to a third aspect of the present invention there is provided a method of operating a tokamak plasma chamber according to the second aspect above. The method comprises, for each of the plurality of toroidal field coils:
passing electrical current around the windings of the toroidal field coil; and
using the cooling mechanism to preferentially cool the first HTS assembly relative to the second HTS assembly to reduce or eliminate a difference in the critical current of the or each HTS tape of the first HTS assembly relative to the critical current of the or each HTS tape of the second HTS assembly.

Where the cooling mechanism comprises one or more cooling channels, using the cooling mechanism may comprise flowing a cryogenic fluid, such as supercritical helium, through the or each cooling channel.

The magnetic field generated by the toroidal field coils may, for example, be such that a strength of the magnetic field at each of the first HTS assemblies is greater than a strength of the magnetic field at each of the second HTS assemblies. Alternatively, or additionally, the field angle between the magnetic field and the plane of the or each ab-plane in the HTS tapes of each of the first HTS assemblies may be greater than the field angle between the magnetic field and the ab-plane of the HTS tapes of each of the second HTS assemblies.

According to a fourth aspect of the present invention, there is provided a central column for a toroidal field coil of a tokamak plasma chamber. The central column comprising a support member having a plurality of channels spaced around a central axis. Each channel has provided therein a conductor element comprising one or more layers of superconductor material for conducting electrical current parallel to the central axis. The central column further comprises a cooling mechanism configured to cool the superconductor material to produce (or maintain) a downward temperature gradient across each conductor element along a radial direction perpendicular to the central axis before or during operation of the tokamak plasma chamber as a fusion reactor, whereby the temperature of each conductor element decreases away from the central axis along the radial direction.

The temperature gradient across each conductor element helps to make the ratio of the electrical current to the critical current (I/I_{c}) within the superconductor material of the conductor element more uniform in the radial direction by compensating, at least to some extent, the increase in magnetic field strength and/or the less optimal field angle with increasing distance from the central axis.

The cooling mechanism may comprise one or more cooling channels extending through the support member through which to flow a cryogenic fluid. A density of the cooling channels and/or respective cross sectional areas of the cooling channels may increase radially across the support member to provide differential cooling to radially inner and outer parts of the support member when cryogenic fluid flows through the cooling channels.

The cooling mechanism may comprise a regulator for controlling the flow rate of cryogenic fluid through the cooling channels, the cooling channels and the regulator being configured to provide greater flow rates through a first set cooling channels than a second set of cooling channels, the cooling channels in the first set being located further from the central axis than the cooling channels in the second set.

Each conductor element may be spaced apart from one or more walls of the channel to define a respective one of the cooling channels.

Each conductor element may comprise a plurality of layers of superconductor material, the layers being arranged substantially perpendicular to the radial direction.

In use, for each conductor element, a mean temperature of a first layer of the superconductor material may be greater than a mean temperature of a second layer of the superconductor material, the first layer being located closer to the central axis than the second layer. The first layer may be a radially innermost layer of the conductor element and the second layer may be a radially outermost layer of the conductor element. The cooling channels may be arranged so that, in use, the cryogenic fluid contacts the second layer of each conductor element.

Each conductor element may contact a portion (e.g. a wall) of the channel of the support member in which the conductor element is provided, the portion extending in a direction perpendicular to the central axis and being made of a thermally conductive material. The thermally conductive material may be or may comprise copper, preferably hard copper.

The superconductor material may be a High Temperature Superconductor, HTS, material, such as REBCO.

Each conductor element may comprise a plurality of stacks of HTS tape arranged side-by-side within the channel, preferably with insulator material being provided between adjacent stacks. The or each cooling channel may span a face of a respective conductor element.

The cryogenic fluid may be helium, preferably supercritical helium.

According to a fifth aspect of the present invention, there is provided a tokamak plasma chamber comprising a central column according to the fourth aspect above and a plurality of toroidal field coils, each toroidal field coil comprising a respective one or more of the conductor elements.

According to an sixth aspect of the present invention, there is provided a method of operating a tokamak plasma chamber comprising a central column according to the fourth aspect above and a plurality of toroidal field coils, each toroidal field coil comprising a respective one or more of the conductor elements, the method comprising flowing cryogenic fluid through the cooling channels before and/or while electrical current is supplied to each of the toroidal field coils. The cryogenic fluid may be helium, preferably supercritical helium. A flow rate of the cryogenic fluid may be increased before and/or during pulsed operation of the tokamak plasma chamber as a fusion reactor.

### BRIEF DESCRIPTION OF THE DRAWINGS

FIG. 1 is a schematic perspective view of an HTS tape of the prior art;

FIG. 2 is a schematic cross section of an HTS tape showing the a-b plane and c-axis of the tape;

FIG. 3A is a schematic cross section view of a tokamak;

FIG. 3B is a schematic axial cross section view of the central column of the tokamak of FIG. 3A;

FIG. 4 is a schematic axial cross section of a segment of the central column of FIGS. 3A and 3B;

FIG. 5 is a schematic axial cross section of a winding pack of the segment of the central column of FIG. 4;

FIG. 6 is a schematic axial cross section of a segment of a central column of a tokamak according to the present invention;

FIG. 7 is a schematic axial cross section of a winding pack of a central column according to the present invention;

FIG. 8 is a schematic axial cross section of a segment of a central column according to the present invention; and

FIG. 9 is a schematic axial cross section of the segment of the central column of FIG. 8 with the results of a simulation of a temperature distribution of the central column superimposed.

### DETAILED DESCRIPTION

It is an object of the present invention to overcome or at least alleviate some of the issues described above for existing central columns of tokamak plasma chambers. In some implementations, the present invention allows central columns to be produced in which, when the tokamak plasma chamber is operated, the distribution of transport electrical current between HTS cables (i.e. HTS “assemblies”) extending along the axis of the central column (which form the “inboard” leg of a toroidal field coil) is more uniform compared to existing central columns. In particular, a more uniform distribution of the transport electrical current may be achieved by providing a cooling mechanism to preferentially cool the HTS tapes in one HTS cable of the toroidal field coil relative to HTS tapes in another HTS cable of the toroidal field coil. Such cooling compensates for a difference (i.e. imbalance) between the critical currents in the HTS material of the two HTS cables. By reducing or eliminating the difference in the critical currents, the transport electrical current is shared more evenly between the HTS cables in the central column. For example, the fraction of transport electrical current to critical current may be more constant for the HTS cables. Differential cooling of HTS material is contrary to approaches used in existing central columns that aim to provide uniformly high cooling rates to the HTS material, regardless of where in the central column the HTS material is located.

The use of HTS material, as opposed to LTS material, generally means that larger temperature differences between two (or more) HTS cables can exist without the risk of thermal runaway occurring due to loss (or partial loss) of superconductivity. For example, in existing magnets that use LTS material, the temperature margin of the LTS material, i.e. the difference between the operating temperature and the critical temperature where a thermal runaway starts, may be less than 1 K. By contrast, for HTS material, the temperature margin may be an order of magnitude higher, so the HTS magnet may tolerate a greater temperature gradient across its windings without loss of superconductivity.

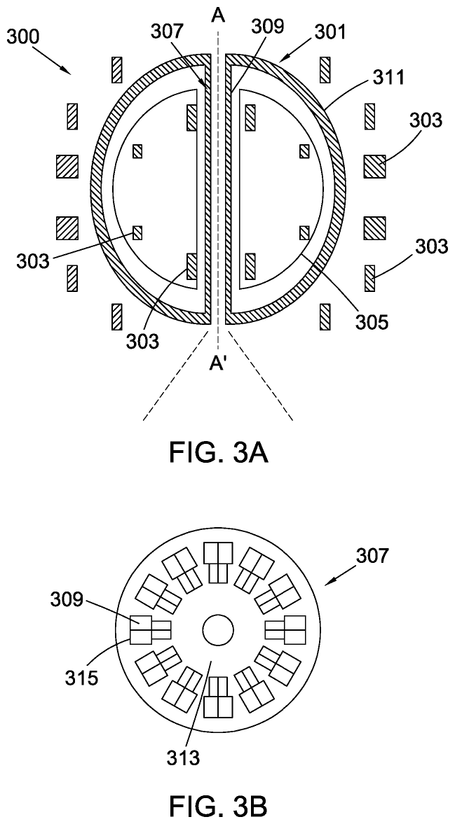

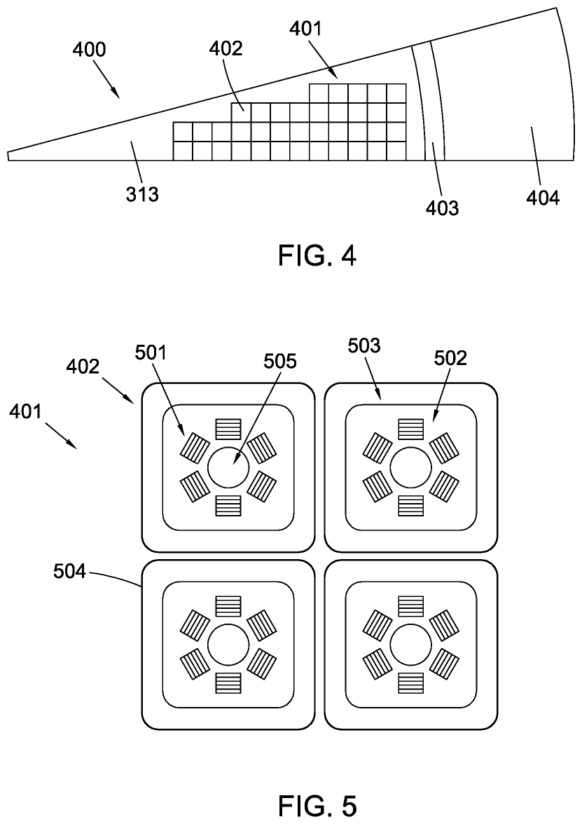

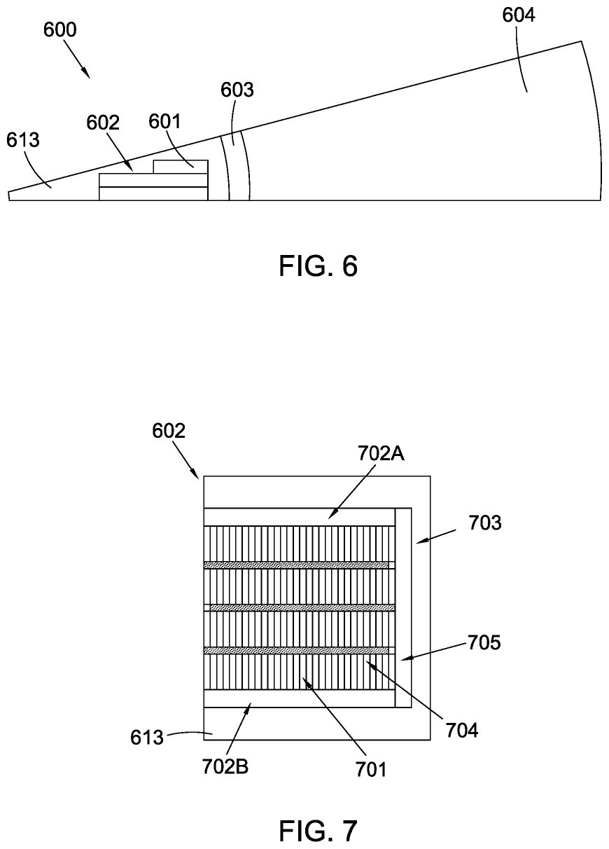

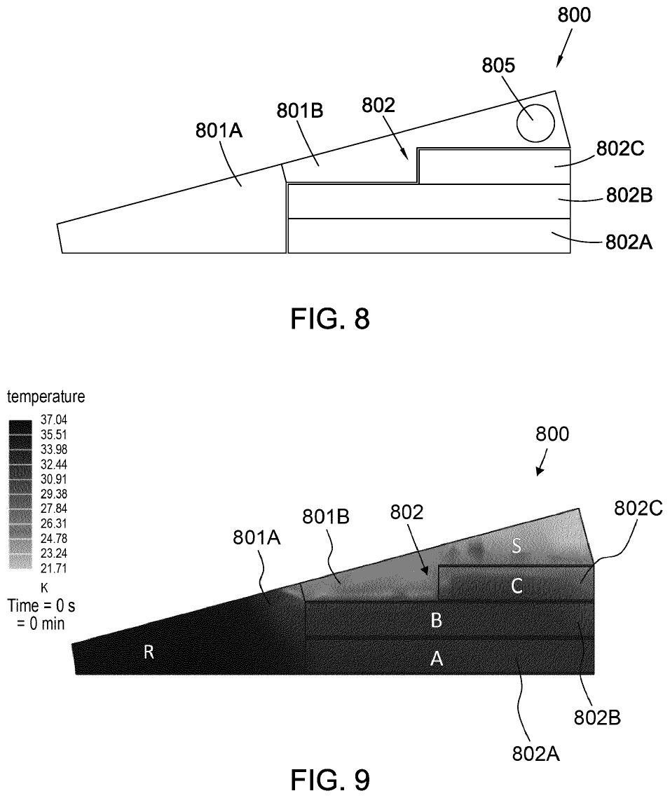

FIG. 6 is an axial cross section of an angular segment of a central column 600 of a tokamak plasma chamber (e.g. the tokamak 300 of FIG. 3A). As for FIG. 4 (and FIG. 8 described below), only one half of the angular segment is shown in FIG. 6, with the omitted half of the angular segment being a mirror image what is shown in the figure. The central column 600 comprises a support member 613 that is similar to the support member 313 of FIGS. 3B and 4. The support member 613 extends parallel to the axis of the central column 600 (i.e. into the page in FIG. 6) and comprises a channel that houses a plurality of HTS assemblies 601 arranged as a “winding pack” 602. Each HTS assembly 601 is elongate in a direction parallel to the axis of the central column 600 (i.e. into the page in FIG. 6). In the implementation shown in FIG. 6, each HTS assembly 601 comprises a plurality of HTS tapes, each aligned so as to have its longest axis (substantially) parallel to the axis of the central column 600. Each HTS assembly 601 also extends in a direction that has at least a component directed towards the axis of the central column 600, i.e. along a radius of the central column. The HTS assemblies 601 are arranged as a stack and the lengths of the HTS assemblies 601 differ in order to make efficient use of the shape of the angular segment, i.e. the lengths of the HTS assemblies 601 at the ends of the stack (e.g. the HTS assembly 601 at the top of the stack with respect to FIG. 6) are shorter than the lengths of the HTS assemblies 601 in the middle of the stack.

The central column 600 also comprises a vacuum gap 603 between the support member 613 and nuclear shielding 604 that surrounds the support member 613 to limit nuclear heating of the support member 613 and the HTS assemblies 601 when the tokamak is in use (i.e. operated as a fusion reactor). The support member 613 may be made from copper (although other metals and/or alloys can be used) and may be formed as a unitary piece or may be formed from two or more pieces, as described below in connection with FIG. 8.

FIG. 7 is an axial cross section of the central column 600 showing a portion of the winding pack 602, which is provided within a channel of the support member 613. The winding pack 602 shown in FIG. 7 comprises a stack of four HTS assemblies 701 (rather than the stack of three HTS assemblies 601 shown in FIG. 6). In general, the stack may comprise any number of HTS assemblies 601, limited only by the sizes of the central column 600 and the dimensions of the HTS tapes. A pair of stabilizer layers 702A, 702B made, for example, from copper or aluminium, are provided on either side of the stack of HTS assemblies 701, between the stack and opposing walls of the channel of the support member 613 that houses the winding pack 602. The walls of the channel act as a structural support 703 for the HTS assemblies 701 to prevent deformation and possible damage of the HTS tapes. In this example, a layer of electrical insulation 704 is provided between respective neighbouring pairs of HTS assemblies 701 in order to isolate the HTS assemblies 701 from one another.

The HTS assemblies 701 each comprise an array of HTS tapes arranged face-to-face, with the HTS tapes running parallel to one another and contacting one another through their respective faces. In this case, each of the arrays of HTS tapes forms part of a respective pancake coil that is part of a toroidal field (TF) coil, such as the TF coils 301 shown in FIG. 3A. This arrangement may allow heat to be transferred efficiently between the HTS tapes such that cooling of the end of the HTS assembly 701 furthest from the axis of the central column 600 may, via the intervening HTS tapes, cool the other end of the HTS assembly 701.

The use of HTS assemblies (“cables”) without twisting or transposition in fusion-scale HTS magnets is controversial. However, these features have been carried over from LTS cables for fusion magnets, nominally to minimise AC losses and ensure equal current sharing between tapes. However, the relatively large size of coated REBCO conductors means that twist pitches are long and loss reduction is minimal in practice. Conversely, the increased thermal stability provided by operation at higher temperatures means that stable operation of large coils without twisting or transposition is feasible. The stacked tape design choice (as in the HTS assemblies 701 described above) also enables 3-5 times higher critical current to be achieved by better aligning the REBCO ab-plane with the local magnetic field vector, which is possible in the TF central column 600 described above.

A cooling channel 705 is provided at a radially outermost end of the winding pack 602, i.e. the central column 600 is arranged such that the winding pack 602 is provided between the axis of the central column 600 and the cooling channel 603. In this example, faces of the HTS assemblies 701 together form one of the walls of the cooling channel 705, such that when a cryogenic fluid (such as supercritical helium) flows through the cooling channel 705 the fluid may contact, and preferentially cool, the radially outermost faces of the HTS tapes.

The central column 600 of FIG. 6 has the same radius as the central column 400 of FIG. 4, but has a winding pack 602 that occupies a significantly smaller area, at least in part because the cooling channel 705 is provided outside of the winding pack 602. The winding pack 602 shown in FIGS. 6 and 7 is therefore able to provide a significantly higher winding pack current density, with J_{wp}˜350 A/mm² than the winding pack 402 of FIG. 4, which comprises CICC type HTS assemblies 402. In addition, a greater proportion of the central column 600 can be used for nuclear shielding 604, leading to lower nuclear heating rates and less damage to the central column 600 when the tokamak is operated, as well as less risk of neutron induced degradation of the critical current in the HTS tapes of the HTS assembles 601. The lower nuclear heating resulting from the thicker neutron shielding 604 also means that the radially inner parts of the HTS assemblies may be cooled by conduction cooling through the support member 613 by surrounding the support member 613 with an annulus of flowing supercritical helium, e.g. as described below with reference to FIG. 8. Furthermore, by locating the cooling channel outside the winding pack 602, the mechanical integrity of the winding pack 602 remains high, such that a thick, high strength jacket (i.e. support structure) around each of the HTS assemblies 701 may not be required, thereby allowing more space to be occupied by the HTS tapes and increasing the thermal conductivity of the HTS assemblies 601.

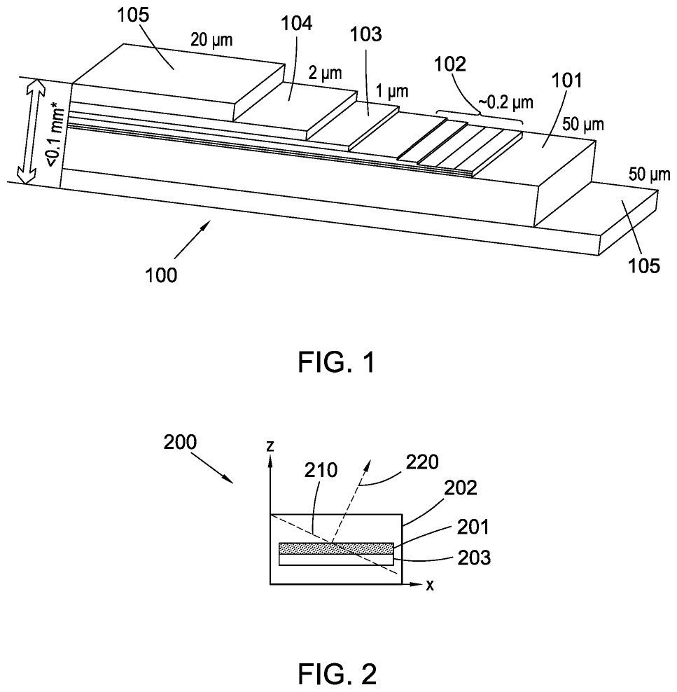

FIG. 8 is an axial cross section through (one half of) a segment of an exemplary central column 800 that is similar to the central column 600 of FIG. 6, except that the support member comprises a radially inner section 801A, that may be made from an Iconel (TM) alloy (for example), in order to resist the high mechanical load on the central column when the toroidal field coils are operated. The support member also comprises a radially outer section or “sidebar” 801B, that may be made of copper, such as hard copper, and which extends across a winding pack 802 that comprises a stack of six HTS assemblies 802A, 802B, 802C (only three of which are shown in FIG. 8), which are similar to the HTS assemblies 701 described in connection with FIG. 7. In this example, the HTS assemblies 802A, 802B, 802C are (substantially straight portions of) three pancake coils that are arranged as a stack and each pancake coil comprising HTS tapes that each include a plurality layers of HTS material (e.g. HTS tape 100 as described above in connection with FIG. 1).

The central column 800 also differs from the central column 600 of FIG. 6 in that an “internal” cooling channel 805 is included within the sidebar 801B, The cooling channel 805 extends in a direction parallel to the axis of the central column 800, i.e. into the page in FIG. 8. This configuration allows the sidebar 801B to be cooled from within by a cryogenic fluid flowing within the cooling channel 805.

Of course, more than one internal cooling channel 805 may be provided within the sidebar 801B, with the number and/or density of the cooling channels 805 and/or the cross sectional area of the channels 805 being varied to alter the temperature distribution within the central column 800 such that the critical currents of the HTS tapes in the HTS assemblies 802A-C is more uniform.

During operation of the tokamak, a toroidal magnetic field is generated by the circulation of electrical current around the windings of the pancake coils comprising the HTS assemblies 802A-C(and the pancake coils of the corresponding other segments of the central column 800, which are not shown in FIG. 8). The magnetic field varies radially across the central column 800, starting from zero on the axis A-A′ of the central column 800 and increasing approximately linearly across the each of the HTS assemblies 802A-C(i.e. from left to right in FIG. 8).

As the HTS assemblies 802A-C extend generally radially inwards (i.e. in a direction having at least a component towards the axis of the central column 800) by different amounts, the HTS tapes of the HTS assemblies 802A-C experience different strengths of magnetic field. As the HTS tapes are, in this example, all arranged parallel to one another, the angle of the magnetic field at each of the HTS tapes also varies depending on which HTS assembly 802A-C the HTS tape belongs to. For example, the alignment of the magnetic field with respect to the HTS tapes of the HTS assembly 802A located towards the middle of the segment (i.e. at the bottom of FIG. 8) is more favourable for superconductivity than the alignment of the magnetic field with respect to the HTS tapes of the HTS assembly 802C closest to the sidebar 801B. The combined effect of the different magnetic field strengths and alignments means that the critical temperatures of the HTS assemblies 802A-C are different. For example, the HTS assembly 802A for which the magnetic field alignment is more favourable, and for which the magnetic field strength across the HTS assembly 802A as a whole is lower, may have a critical temperature of around 40 K, whilst the other two HTS assemblies 802B-C may have lower critical temperatures of around 37 K and 32 K respectively.

FIG. 9 shows, superimposed on the segment of the central column 800 of FIG. 8, the results of a Monte Carlo N-Particle Transport (MCNP) simulation and thermal finite element analysis (FEA) for a temperature distribution in the central column 800 after pulsed operation of the tokamak as a fusion reactor, taking into account active cooling by the supercritical helium flow. The cooling channel 805 is omitted from FIG. 9 for clarity. Prior to the fusion pulse, each of the HTS assemblies 802A-C is cooled to around 20 K. During a 35 MW fusion pulse, approximately 50 KW of heat is transferred to the central column 800, causing the respective temperatures of each of the HTS assemblies 802A-C to increase to around 35 K (HTS assembly 802A), 33.5 K (HTS assembly 802B) and 31 K (HTS assembly 802C). The simulation indicates that the nuclear heat load varies radially over the central column 800, with the highest nuclear heat load being found to occur at the radially outermost edges of the HTS assemblies 802A-C and decreasing by a factor of around two close to the axis of the central column 800. However, the temperature varies in the opposite sense because of the location of the cooling channel 805 as more heat flows to this channel and is removed to the helium coolant from the components closest to the channel.

Alternatively or additionally, an “external” cooling channel may be provided outside the sidebar 801B, which spans both the winding pack 802 (i.e. the faces of the HTS assemblies 802A-C) and a face of the sidebar 801B, such that one of the walls of the cooling channel is formed by the radially outermost faces of the sidebar 801B and the HTS assemblies 802A-C together. This configuration allows these faces of the sidebar 801B and the HTS assemblies to be cooled by a cryogenic fluid flowing within the cooling channel. In one example, the cooling channel may extend continuously around the central column 800 to form an annulus that surrounds the HTS assemblies 802A-C and sidebars 801B of each of the segments. In use, supercritical helium then flows through the cooling channel to cool the sidebar 801B and the HTS assemblies 802A-C directly, i.e. the supercritical helium (or other cryogenic fluid) may contact respective faces of the sidebar 801B and the HTS assemblies 802A-C to cool them. In particular, the face of the sidebar 801B that contacts the supercritical helium may be contiguous with the rest of the sidebar 801B, with no interface within the sidebar 801B between different regions of the sidebar 801B, to ensure high thermal conductivity.

While various embodiments of the present invention have been described above, it should be understood that they have been presented by way of example, and not limitation. It would be apparent to one skilled in the relevant art(s) that various changes in form and detail could be made therein without departing from the spirit and scope of the invention.

1. A central column for a tokamak plasma chamber, the central column comprising:
a toroidal field coil comprising first and second high temperature superconductor, HTS, assemblies comprising a respective one or more HTS tapes for conducting electrical current parallel to an axis of the central column, each of the HTS tapes comprising HTS material having an associated critical current that is dependent on a magnetic field at the HTS tape when the toroidal field coil is in use;
a cooling mechanism configured to preferentially cool the first HTS assembly relative to the second HTS assembly to reduce or eliminate a difference in the critical current of the or each HTS tape of the first HTS assembly relative to the critical current of the or each HTS tape of the second HTS assembly; and
a support member having one or more channels, the first and second HTS assemblies being provided in the one or more channels of the support member.

2. A central column according to claim 1, wherein the critical current of each HTS tape is inversely dependent on the strength of the magnetic field at the HTS tape such that the critical current decreases as the strength of the magnetic field increases, and the strength of the magnetic field at the first HTS assembly is greater than the strength of the magnetic field at the second HTS assembly.

3. A central column according to claim 1, wherein each of the HTS tapes has an associated plane defined with respect to a crystal structure of the HTS material of the HTS tape and the critical current of each HTS tape depends on a field angle between the magnetic field at the HTS tape and the plane of the HTS tape, the critical current decreasing as the field angle increases, the HTS assemblies being arranged such that the field angle between the magnetic field and the plane of the or each HTS tape of the first HTS assembly is greater than the field angle between the magnetic field and the plane of the or each HTS tape of the second HTS assembly.

4. A central column according to claim 3, wherein for each of the HTS assemblies, the respective planes of the HTS tapes of the HTS assembly are parallel to one another.

5. A central column according to claim 4, wherein the planes of the HTS tapes in the first HTS assembly are parallel to the planes of the HTS tapes in the second HTS assembly.

6. A central column according to claim 1, wherein the cooling mechanism comprises one or more cooling channels through which to flow a cryogenic fluid.

7. A central column according to claim 6, wherein the or each cooling channel extends in a direction parallel to the axis of the central column.

8. A central column according to claim 6, wherein a thermal impedance between the or each cooling channel and the first HTS assembly is less than a thermal impedance between the or each cooling channel and the second HTS assembly.

9. A central column according to claim 6, wherein a shortest distance between the or each cooling channel and the first HTS assembly is less than a shortest distance between the or each cooling channel and the second HTS assembly, each of the distances being measured in a plane perpendicular to the axis.

10. (canceled)

11. A central column according to claim 1, wherein the or each channel extends in a direction parallel to the axis of the central column.

12. A central column according to claim 1, wherein at least a part of the support member comprises a body portion made of a thermally conductive material.

13. A central column according to claim 12, wherein the thermally conductive material comprises copper.

14. A central column according to claim 12, wherein the cooling mechanism is configured to cool the body portion through a face of the body portion, the body portion being in contact with the first HTS assembly and/or the second HTS assembly through one or more walls of the or each channel of the support member in which the first and second HTS assemblies are provided, whereby the first HTS assembly and/or the second HTS assembly is or are cooled by the body portion.

15. A central column according to claim 12, wherein the cooling mechanism comprises a cooling channel within the body portion, the body portion being in contact with the first HTS assembly and/or the second HTS assembly through one or more walls of the or each channel of the support member in which the first and second HTS assemblies are provided, whereby the first HTS assembly and/or the second HTS assembly is or are cooled by the body portion.

16. A central column according to claim 12, wherein at least a portion of the second HTS assembly is located radially inwards of the first HTS assembly, the portion being in thermal contact with the body portion, whereby heat is transferred from the portion of the second HTS assembly to the cooling mechanism via the body portion.

17. A central column according to claim 12, wherein the support member comprises another part located radially inwards of the body portion and having a higher mechanical strength than the body portion.

18. A central column according to claim 1, further comprising a winding pack comprising the first and second HTS assemblies and a support member extending across a side of the winding pack, the cooling mechanism comprising a channel within the support member.

19. A central column according to claim 1, wherein the first and second HTS assemblies each comprise part of respective planar coils comprising nested windings of HTS tapes wound about an axis.

20. A tokamak plasma chamber comprising a central column according to claim 1 and comprising a plurality of toroidal field coils configured to provide a toroidal magnetic field inside the plasma chamber when electrical current is passed around windings of the toroidal field coils, each toroidal field coil comprising a respective first and second HTS assembly.

21. A method of operating a tokamak plasma chamber according to claim 20, the method comprising, for each of the plurality of toroidal field coils:
passing electrical current around the windings of the toroidal field coil; and
using the cooling mechanism to preferentially cool the first HTS assembly relative to the second HTS assembly to reduce or eliminate a difference in the critical current of the or each HTS tape of the first HTS assembly relative to the critical current of the or each HTS tape of the second HTS assembly.
